(19) United States
(12) Patent Application Publication
(10) Pub. No.: US 2006/0196131 A1
(43) Pub. Date: Sep. 7, 2006

(54) Stained glass mounting lobe

(76) Inventor: Donald Gary Klein, Campbellsport, WI (US)

Correspondence Address: Donald G. Klein, 1502 Old Bridge Rd., Campbellsport, WI, 53010, US

(21) Appl. No.: 11/071,472

(22) Filed: Mar. 4, 2005

(51) Int. Cl. E06B 3/66

(52) U.S. Cl. 52/204.59

(57) ABSTRACT

Being an artist,helped to add an artistic expression to the invention,the unique mounting lobe design when incorporated with the custom low profile came and dimensions,is to provide a product with many advantages over other related window decoration products. The lobe design in combination with the low profile came,makes the “Stained Glass Inserts”™., possible to provide a stained glass window treatment that Fits the most common wood and vinyl window sashes to date. A stained glass application that requires no removal of the window glass pane,no window sash adaptations,looks like an original installation and still provide a safe,full function relationship with the window and it's accessories. The design of the inventions greatest asset, to provide easy installation of stained glass to a pre-existing window for persons with minimal home improvement skills.

The invention is a unique mounting lobe design that when incorporated with a low profile came and stained glass arrangement, is to provide a fixed,exclusive stained glass window treatment.

I designed the mounting lobe to work with the custom low profile came to provide the strength and integrity needed to function with the window or window in a door. Also strength in terms of malfunction in the event a window should fall harshly with excessive force down to it's sill.

The came is designed to lay flat against a windows clear glass pane. When the stained glass arrangement is framed by the custom low profile came,combined with the unique mounting lobe design,provides an exclusive, fixed, stained glass window treatment with many advantages called, “Stained Glass Inserts”, ™.

An arrangement of stained glass squares and rectangles are pre-cut using a glass cutter.

Low profile came is pre-cut at 0.0312 inch oversize the stained glass piece outer dimensions. This is done to accomodate a rubber seal that is put between the cames inside dimensions and the piece of stained glass within.

Since stained glass thickness and expansion rates are different depending on color and manufacturer, the rubber seal helps prevent cracking of stained glass due to window malfunction and glass expansion caused by heat from the sun.

The pre-cut stained glass pieces are arranged in a pattern,that when soldered together,provide the maximum strength possible when framed by came in that section of the arrangement.

The largest square piece of stained glass closest to the corner of the arrangement or pattern,being the primary color. The stained glass pattern is soldered together in the shape of a right-angle in a-calibrated jig fixture using custom low profile came. Custom low profile inner bar came is soldered between two pieces of stained glass within it's outer bar came. Liquid solder and a fine tip torch is used to solder the came to provide strength and flow.

The outer edge of the “Stained Glass Inserts”™., came is soldered in a jig fixture at a 90 degree angle so it will fit tight against a windows stiles,top,middle or bottom rail which ever corner applies.

An arched piece of came is soldered on both ends of the insert,with a space left open that contains no stained glasss, to help create an artistic blend of the pre-manufactured windows clear glass pane and the stained glass in the insert. Conventional wire solder and an electric soldering iron are used in this process.

Mounting lobes are cut with metal shears from pre-measured flat ⅜ inch stock, deburred and shaped on an abrasive electric wheel.

Mounting lobes are checked in a gauge for the proper shape, thickness and dimensions.

Mounting lobes are soldered on the inserts outer bar came at a precise distance apart in a calibrated jig fixture using liquid solder and a fine tip torch.

The mounting lobes holes are gauged and marked before drilling. Mounting lobe holes are drilled in the gauge marking in a jig fixture using a 3/32 inch metal drill bit and drill press at 650 R.P.M.

The mounting lobes thickness, height, width, hole diameter, hole pitch angle,center hole distance from the bottom of the custom low profile came,are of precise distance. These dimensions are critical to the structural integrity that makes the “Stained Glass Insert”,™ connection to a pre-existing window possible. The dimensions of the mounting lobe, when combined with the stained glass arrangement,framed by the low profile came,provides the ability of the insert to be installed in the corner of the window sash next to the pre-existing windows clear glass pane. This displays a visual close integrated relationship between the windows clear glass pane and the “Stained Glass Insert”,™. that gives the look of an original,fixed stained glass installation.

The “Stained Glass Insert”™. unique lobe and low profile came design,is meant for use and installation in new windows as well as older window sashes,with a pre-manufactured minimum 3/16 inch edge rabbet cut, which is the most common in wood and vinyl window sashes to date.

After assembly,the insert is inspected and cleaned with window cleaner.

The insert is provided as a kit. Installation requires the insert to be installed indoors in the corners of pre-manufactured windows next to it's clear glass pane. It is recommended the windows clear glass pane is cleaned with window cleaner prior to installation.

For installation-Place “Stained Glass Insert”™. on the inside corner of the windows clear glass pane tightly to the corner of the window sash. Starting with the mounting lobes closest to the inside corner first, Small ⅜ inch panhead philips screws are provided for installation. No pre-drilling is required. Place screw body inside the hole of the mounting lobe and screw into wooden or vinyl as with a philips screw driver.

The unique mounting lobe in combination with the low profile came is a stained glass application that fits the most common pre-existing window sash dimensions to date, blends close to a windows clear glass pane and appears to be an original installation. Along with one of it's greatest assets,provides easy installation of stained glass to a persons home for persons with minimal home improvement skills.

### INVENTION BACKGROUND

The invention “Stained Glass Inserts”™., mounting lobe, field of endeavor to which it pertains to,is to be used as a safe,stained glass mounting system for pre-existing window sashes,with a pre-manufactured minimum 3/16 inch edge rabbet cut.

### DESCRIPTION OF RELATED ART

In related art,a stained glass artist would display their stained glass arrangement indoors in front of a windows clear glass pane,hung by suspension chains anchored by hooks,nails,or eye-bolts into the window framework or wall. This type of installation most often interferes with the full function or movement of curtains and blinds. The blowing of wind in an opened window possibly causing damage to the stained glass arrangement or the windows clear glass pane. This type of installation also does not look like an original fixed installation. A fixed original installation normally requires extensive came framework or the removal of the windows clear glass pane that must be integrated with the stained glass and came than reinstalled into the sash to retain natural lighting indoors from the sun. Including the ability to see outside clearly through the windows clear glass pane. Other installations require having to alter the windows sash to accommodate different dimensions in the stained glass application. These original stained glass installations come at a great expense. Some related stained glass treatments require stained glass paints or stains that are normally painted on clear glass or plastic by hand which is very time consuming. Other imitation stained glass products require adhesives like stained glass stickers that normally bubble or peal in time with different climate changes.

### SUMMARY OF THE INVENTION

The objective of the unique lobe design,is to provide an easier application to persons that desire to add the beauty and character of stained glass to a pre-existing window sash to have an integrated look of stained glass and the windows clear glass pane. The look of an original installation along with many other advantages.

The lobe design in combination with the custom low profile came, is designed to be installed in pre-existing windows with a minimum 3/16 inch edge rabbet cut, which is the most common in wood and vinyl window sashes to date. When installed into a windows wooden or vinyl sash,provides the beauty of stained glass as well as the structural integrity needed to maintain a long lasting relationship and function with the pre-existing window. Safe function in terms of working with the opening or closing of the window. Also function in terms of structural integrity and performance needed to help prevent damage to the stained glass as well as the pre-existing window or persons, in the event a window should fall harshly with excessive force down to it's sill.

The mounting lobes of the “Stained Glass Inserts”™., provides and requires indoor installation,thus protected from damage from outdoor frost,ice and harsh weather that could crack the stained glass from ice expansion. Other advantages include the ability to provide stained glass to a pre-existing window without making changes or adaptations in the window sash,glazing or spackling putty. To provide an easy application of stained glass to a window without removing the clear glass pane from the window sash. To reduce the need to hang the stained glass and came from eye-bolts, nails,hooks or chains for exhibition possibly reducing the full function of window curtains or blinds.

Provides the realistic look of genuine stained glass over imitation glass paints,stains or imitation stained glass stickers.

The mounting lobes thickness,height,width,hole diameter, hole pitch and center hole distance from the bottom of the custom came are of precise distance and are critical to the structural integrity that makes the “Stained Glass Inserts”™., connection to a pre-existing window possible.

The design provides easy removal of stained glass if a window is in need of repair,including one of it's greatest assets, easy installation. All these assets provide an easy answer to beautifying new windows as well as old windows. Old windows that have no easy answer to making them beautiful again.

### DESCRIPTION OF THE INVENTION

### Stained Glass Mounting Lobe

The invention is a unique mounting lobe design that when incorporated with a low profile came and stained glass arrangement,is to provide a fixed,exclusive stained glass window treatment.

I designed the mounting lobe to work with the custom low profile came to provide the strength and integrity needed to function with the window or window in a door. Also strength in terms of malfunction in the event a window should fall harshly with excessive force down to it's sill.

The mounting lobe is also designed to be easily accessible for the stained glass application to a pre-existing window sash as well as cosmeticly appealing.

All drawing distances are specified in inches. Came and lobes are made of the common medium used for stained glass application of lead metal composition.

The came is designed to lay flat against a windows clear glass pane. When the stained glass arrangement is framed by the custom low profile came,combined with the unique mounting lobe design,provides an exclusive, fixed stained glass window treatment with many advantages called, “Stained Glass Inserts”,™.

An arrangement of stained glass squares and rectangles are pre-cut using a glass cutter.

Low profile came is pre-cut at 0.0312 inch oversise the stained glass piece outer dimensions. This is done to accomodate a rubber seal that is put between the cames inside dimensions and the piece of stained glass within.

Since stained glass thickness and expansion rates are different depending on color and manufacturer,the rubber seal helps prevent cracking of stained glass due to window malfunction and expansion caused by heat from the sun.

The pre-cut stained glass pieces are arranged in a pattern, that when soldered together,provide the maximum strength possible when framed by came in that section of the arrangement.

The largest square piece of stained glass closest to the corner of the right-angle shape of the pattern, being the primary color. The stained glass pattern is soldered together in the shape of a right-angle in a calibrated jig fixture using custom low profile came. Custom low profile inner bar came is soldered between two pieces of stained glass within it's outer bar came. Liquid solder and a fine tip torch is used to solder the came to provide strength and flow.

The outer edge of the “Stained Glass Inserts”™. came is soldered in a jig fixture at a 90 degree angle so it fit tight against a windows stiles, top, middle or bottom rail which ever corner applies.

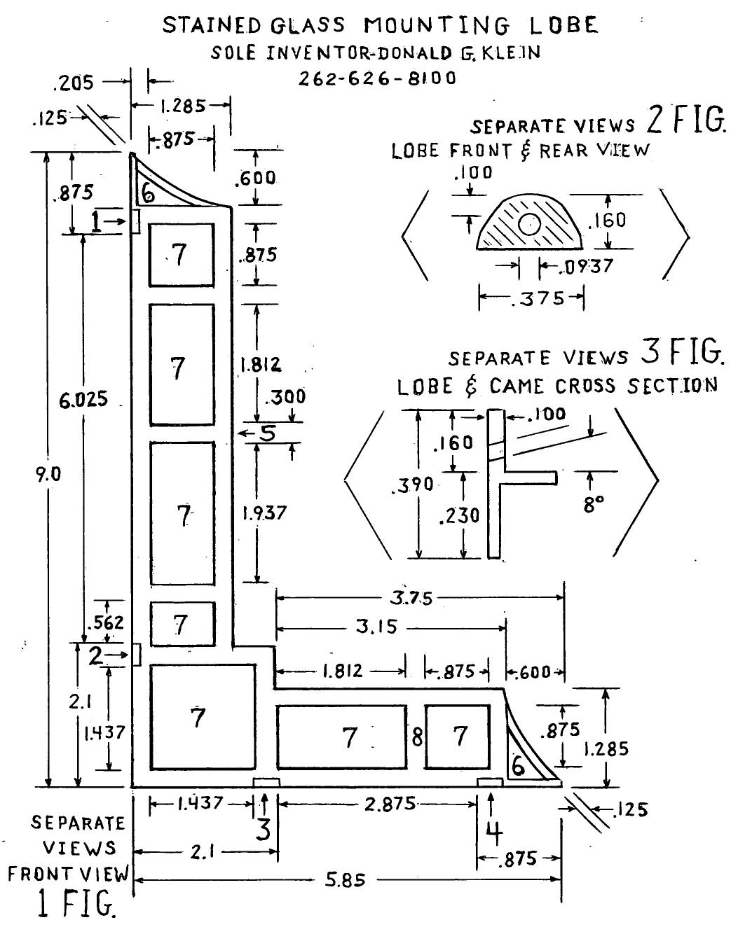

An arched piece of came is soldered on both ends of the insert, with a space left open that contains no stained glass, to help create an artistic blend of the pre-manufactured windows clear glass pane and the stained glass in the insert. Arched came and open space containing no stained glass is depicted in FIG.1, FIG.9, Reference points number 6, of drawings. Conventional wire solder and an electric soldering iron are used in this process.

Mounting lobes are cut with metal shears from pre-measured flat ⅜ inch stock,deburred and shaped on an abrasive electric wheel.

Mounting lobes are checked in a gauge for the proper shape, thickness and dimensions.

Mounting lobes are soldered on the inserts outer bar came at a precise distance apart in a calibrated jig fixture using liquid solder and a fine tip torch.

Lobe locations are depicted in the drawings of FIG. 1, Reference numbers 1,2,3,4 in a left corner insert.

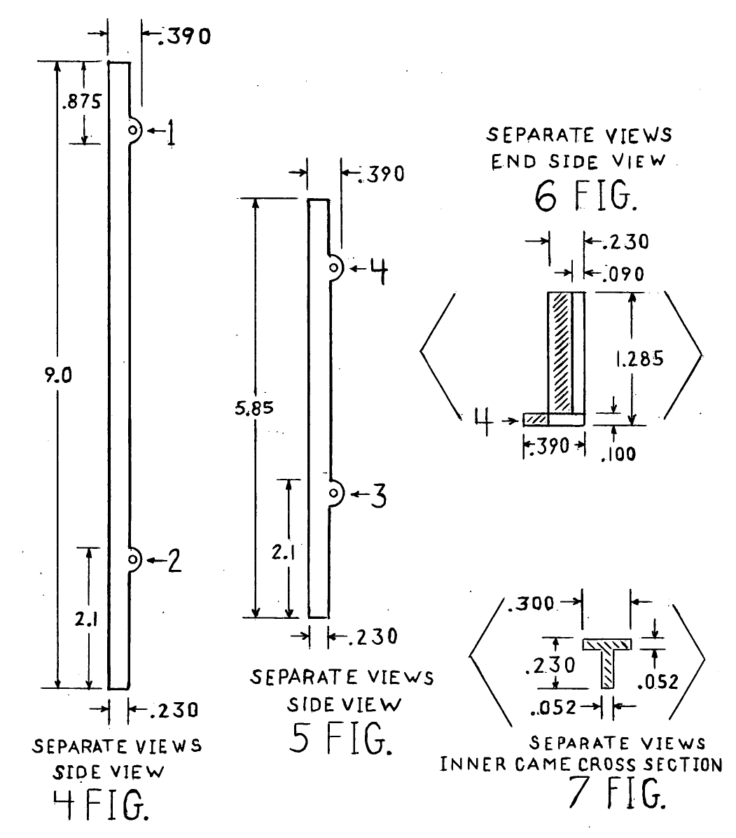

Lobe locations are depicted in the drawings of FIG. 4, Reference numbers 1,2, showing a side view of a left inserts 9 inch outer bar section.

Lobe locations are depicted in the drawings of FIG. 5, Reference numbers 3,4, showing the side view of a right corner inserts 5.85 inch outer bar came section.

Lobe locations are depicted in the drawings of FIG. 9, Reference numbers 1,2,3,4, in a right corner insert.

An exploded lobe side view soldered to outer bar came is depicted in the drawings in FIG.3. Cross section.

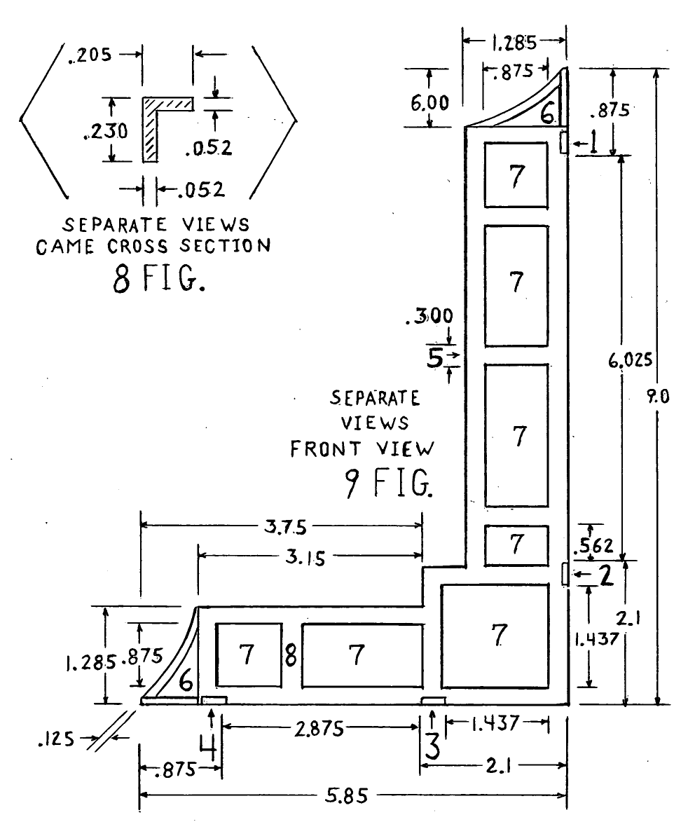

An exploded end side view of an insert and lobe is depicted in the drawings of FIG. 6.

Note:A right corner inserts dimensions are the same as a left corner inserts dimensions. The horizontal 5.85 inch section of a right corner insert is reversed the opposite direction of a left corner insert so when they are displayed in the same level of a window sash, they are equal in height and width.

The mounting lobes holes are gauged and marked before drilling.

Mounting lobe holes are drilled in the gauge marking in a jig fixture using a 3/32 inch metal drill bit and drill press at 650 R.P.M.

After assembly,the “Stained Glass Inserts”™. are inspected and cleaned with window cleaner.

The mounting lobes thickness,height,width,hole diameter, hole pitch angle and center hole distance from the bottom of the custom came are of precise distance and are critical to the structural integrity that makes the “Stained Glass Inserts”,™. connection to a pre-existing window possible.

The lobe design in combination with the low profile came, is designed to be installed in pre-existing windows with a minimum 3/16 inch edge rabbet cut,which is the most common in wood and vinyl window sashes to date.

The mounting lobes of the Stained Glass Inserts”™., provides and requires indoor installation,thus protected from damage from outdoor Frost,ice and harsh weather that could crack the stained glass from ice expansion. Other advantages include the ability to provide stained glass to a pre-existing window without making changes or adaptations in a windows sash,glazing or spackling putty. To provide an easy application of stained glass to a window without removing the clear glass pane from the window sash. To reduce the need to hang the stained glass and came from eye-bolts, nails, hooks or chains for exhibition possibly reducing the full function of window curtains or blinds. Provides the realistic look of genuine stained glass.

For installation-Place “Stained Glass Insert”™., on the inside corner of the windows clear glass pane tightly to the corner of the window sash. Starting with the mounting lobes closest to the inside corner first,small ⅜ inch panhead philips screws are provided for installation. No pre-drilling is required. Place screw body inside the hole of the mounting lobe and screw into wooden or vinyl sash with a philips screw driver.

### DRAWING DESCRIPTION

1 FIG. Depicts a complete frontal view of a left “Stained Glass Insert”™., four lobe locations Ref.#1-2, 3, 4.

Example of inner bar came Ref.#5.

Two open spaces containing no stained glass Ref.#6.

Stained glass locations Ref.#7.

Copyright symbol,inventor author logo on inner bar came Ref.#8.

FIG. Depicts an exploded cross section view of a lobe front and rear view and dimensions.

3 FIG. Depicts an exploded cross section view of a lobe and outer bar came soldered together. This view also shows the lobe hole and pitch. Hatching lines are not added so not to confuse angle lines in drawing.

4 FIG. Depicts a side view of the 9 inch length of a left insert. Two lobe locations are shown Ref.#1,2. For a right corner insert view,simply-place lobes on the opposite side,being the left side of the came.

5 FIG. Depicts a side view of a right “Stained Glass-Inserts”™., 5.85 inch length of outer bar came, it's dimensions and lobe locations. Two lobe locations are shown Ref.# 3,4. Again for an accurate depiction of an inserts left view of the same length, simply place the two lobes on the opposite side of the came.

6 FIG. Depicts a side view of the end of the insert along with the lobe and it's dimensions. This is an exploded view.

7 FIG. Depicts an exploded cross section view of custom inner bar came and it's dimensions. Inner bar came is used between two pieces of stained glass within it's outer bar came.

8 FIG. Depicts an exploded cross section view of custom outer bar came and it's dimensions.

9 FIG. Depicts a complete frontal view of a right “Stained Glass Insert”™., four lobe locations Ref.# 1-2, 3,4.

Example of inner bar came Ref.# 5.

Two open spaces containing no stained glass Ref.# 6.

Stained glass locations Ref.# 7.

Copyright symbol,inventor author logo on inner bar came Ref.# 8.

All References and Drawing distances are specified in inches.

### DRAWING REFERENCE POINTS

Reference point numbers 1,2,3,4, are mounting lobes and their locations.

Reference point number 5, is an example of inner bar came which is used between two pieces of stained glass within it's outer bar came.

Reference point number 6, is the location of open areas containing no stained glass creating a blend of the existing windows clear glass pane and the stained glass in the insert.

Reference point number 7, are assorted colors of stained glass and their locations bordered in outer and inner came.

Reference point number 8, are the locations of the “Stained Glass Inserts”™., copyright symbol and inventor-author logo on inner bar came.

Number 8, is the last reference point number.

What I claim as my invention is:

1. The unique mounting lobe that provides many advantages for the “Stained Glass Inserts”™., to be used as a fixed stained glass application to window sashes with a pre-manufactured minimum 3/16 inch edge rabbet cut which is the most common in pre-existing wood and vinyl sashes to date.
